(19) United States
(12) Patent Application Publication
(10) Pub. No.: US 2016/0271992 A1
(43) Pub. Date: Sep. 22, 2016

(54) BLANKET FOR OFFSET PRINTING AND FINE PATTERN MANUFACTURED BY USING THE SAME

(71) Applicant: LG CHEM, LTD., Seoul (KR)

(72) Inventors: Beom Mo KOO, Daejeon (KR); Kun Seok LEE, Daejeon (KR); Seung Heon LEE, Daejeon (KR); Yong Goo SON, Daejeon (KR); Jooyeon KIM, Daejeon (KR)

(21) Appl. No.: 14/442,335

(22) PCT Filed: Aug. 1, 2014
(86) PCT No.: PCT/KR2014/007106

§ 371 Date: May 12, 2015

(30) Foreign Application Priority Data
Aug. 1, 2013 (KR) 10-2013-0091713

(51) Int. Cl. B41N 10/04

(52) U.S. Cl. CPC B41N 10/04

(57) ABSTRACT

Provided are a blanket for offset printing and a fine pattern manufactured by using the same.

### CROSS-REFERENCE TO RELATED APPLICATIONS

This application claims priority to and the benefit of Korean Patent Application No. 10-2013-0091713 filed in the Korean Intellectual Property Office on Aug. 1, 2013, the entire contents of which are incorporated herein by reference.

### TECHNICAL FIELD

The present application relates to a blanket for offset printing and a fine pattern manufactured by using the same.

### BACKGROUND ART

In general, electronic devices such as a liquid crystal display and a semiconductor device are manufactured by forming patterns of many layers on a substrate. In order to form the patterns, up to now, a photolithography process has been frequently used. However, since the photolithography process needs to manufacture a predetermined pattern mask and chemical etching and striping processes need to be repeated, there are problems in that a manufacturing process is complicated and a lot of chemical wastes which are harmful to the environment are generated. Due to the problems, the manufacturing costs are increased and thus the competitiveness of products deteriorates. As a new method of forming patterns for solving disadvantages of the photolithography process, a roll printing method using a printing roll is proposed.

The roll printing method includes various methods, but may be largely divided into two types of a gravure printing method and a reverse offset printing method.

The gravure printing method, as a printing method in which printing is performed on a concave plate by smearing ink and removing the remaining ink, is known as a method suitable for printing in various fields such as publishing, packaging, cellophane, vinyl, and polyethylene, and researches for applying the gravure printing method to manufacturing an active element or a circuit pattern applied to the display device have been conducted. In the gravure printing method, since the ink is transferred onto the substrate by using a transfer roll, even in a large-area display device, patterns may be formed through one transfer by using a transfer roll corresponding to an area of the desired display device. The gravure printing method may be used for forming an ink pattern for a resist on the substrate and patterning various patterns of the display device, for example, metal patterns for a TFT as well as a gate line and a data line which are connected with the TFT, a pixel electrode, and a capacitor in the case of a liquid crystal display device.

However, generally, a blanket used in the gravure printing method is manufactured by casting a silicon-based resin in a hard master mold, and there is a limit to manufacturing the blanket manufactured above to have a uniform thickness and it is difficult to mass-produce the blanket on a pilot scale. As a result, in order to precisely form a fine pattern, the reverse offset printing method is mainly adopted.

The related art for the reverse offset printing method and the printing apparatus may refer to the following Documents 1 to 3 which are filed and published by applicants of the present application.

[Document 1] Korean Patent Publication No. 10-2008-0090890 Oct. 9, 2008.

[Document 2] Korean Patent Publication No. 10-2009-0020076 Feb. 26, 2009.

[Document 3] Korean Patent Publication No. 10-2009-0003883 Jan. 12, 2009.

All contents of the specifications of Documents 1 to 3 are the description for the related art of the present application and combined with the specification of the present application.

The reverse offset printing method is a very spotlighted technology in terms of reducing costs and improving the production speed when the pattern is formed, but in order to obtain a precise pattern, a high-quality blanket is required. That is, according to a characteristic of the blanket, the quality of the pattern may be determined, and as a result, it is a very important technical object to manufacture a high-quality blanket for printing.

### SUMMARY OF THE INVENTION

The present application has been made in an effort to provide a blanket by which fine patterns can be printed.

An exemplary embodiment of the present application provides a blanket for offset printing including: a cushion layer; a support layer provided on the cushion layer; and a printing layer provided on the support layer, in which the surface tackiness of the printing layer is 7 gf or more and 20 gf or less.

Another exemplary embodiment of the present application provides a printing roll including the blanket for offset printing covering a periphery of a roll support.

Yet another exemplary embodiment of the present application provides a fine pattern having a line width of 1 μm or more and 5 μm or less formed by using the blanket for offset printing.

According to the exemplary embodiment of the present application, a blanket for offset printing may form a fine pattern of 5 μm or less.

In the case of forming the fine pattern by using the blanket for offset printing of the present application, there is an advantage in that an error rate is very low. Therefore, in the case of forming the fine pattern by using the blanket for offset printing of the present application, there are advantages in that process efficiency may be enhanced and manufacturing costs may be reduced.

### BRIEF DESCRIPTION OF THE DRAWINGS

FIG. 1 is a diagram illustrating an apparatus of forming a pattern including a blanket for printing and a method of forming a pattern by using the same according to an exemplary embodiment of the present application.

FIG. 2 is a diagram illustrating a ball tack test apparatus for measuring surface tackiness of a printing layer of a blanket for offset printing according to the exemplary embodiment of the present application.

FIG. 3 is a diagram illustrating a mesh pattern with a line width of 4.5 μm which is formed by using the blanket for offset printing according to the exemplary embodiment of the present application.

FIG. 4 illustrates a printed result according to Comparative Example 1.

FIG. 5 illustrates a printed result according to Comparative Example 2.

### DETAILED DESCRIPTION

Hereinafter, the present application will be described in more detail.

The present application provides a blanket for offset printing including: a cushion layer; a support layer provided on the cushion layer; and a printing layer provided on the support layer, in which the surface tackiness of the printing layer is 7 gf or more and 20 gf or less.

According to an exemplary embodiment of the present application, the blanket for offset printing may be a blanket for reverse offset printing.

The reverse offset printing of the present application may be a kind of roll printing methods in which a pattern formed on a printing plate is formed on a photoresist coated on a roll and then the formed pattern is transferred to a substrate to be formed with the pattern.

In the reverse offset printing method, ink is coated on a blanket roll, an unnecessary portion is removed (Off) by a convex pattern (cliché) of the printing plate, and then the coated ink is transferred (Set) to the substrate. In the reverse offset printing method, in order to increase viscosity of the coated ink and maintain the viscosity at a predetermined value, methods such as natural drying, blowing drying, and hot air drying are used.

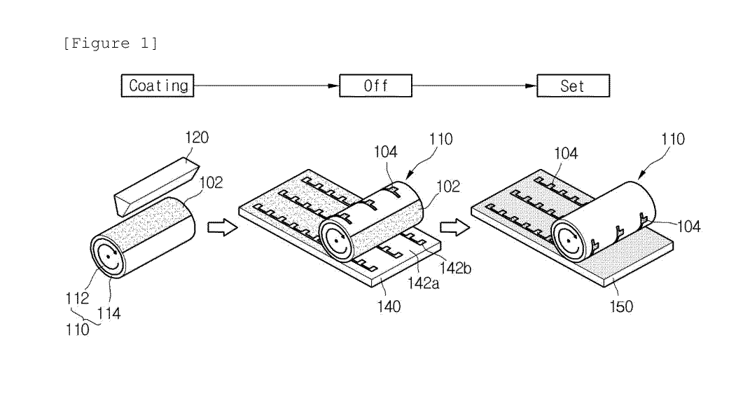

FIG. 1 is a diagram illustrating an apparatus of forming a pattern including a blanket for printing and a method of forming a pattern by using the same according to an exemplary embodiment of the present application.

As illustrated in FIG. 1, the apparatus of forming the pattern includes a blanket roll 110, a slit coater 120, a printing plate 140, and a transferred substrate 150. The blanket roll 110 is constituted by a rotatable roll frame 112 and a blanket covering the roll frame 112 and providing a coating surface of an ink 102 according to rotation of the roll frame 112. The roll frame 112 may be made of a metal material.

The slit coater 120 is an apparatus of spraying the ink 102 to the blanket 114 and spaced apart from the blanket 114 at a predetermined distance by considering the thickness of the ink. A surface of the slit coater 120 which faces the blanket 114 has a predetermined area and a length extended in one direction. Further, a nozzle of the slit coater 120 through which the ink 102 is sprayed has a slit shape having a minute width and is elongated in one direction in response to the length of the slit coater 120.

The ink 102 sprayed from the minute slit of the slit coater 120 is attached to the blanket 114 by a surface tension therebetween not to be detached from the blanket 114 but to maintain a predetermined height.

A solvent for maintaining viscosity during coating at 2 cp to 10 cp is included in the ink 102 sprayed from the slit coater 120. When the solvent has a relatively low evaporation point, the solvent serves to maintain the viscosity during coating at 2 cp to 10 cp so that the nozzle can be coated. Further, the ink 102 may be made of a metal-based ink.

The printing plate 140 is to pattern the ink 102 coated on the surface of the blanket roll 110 with proper viscosity for offset and includes a plurality of convex portions 142a and a plurality of concave portions 142b. The ink 102 coated on the surface of the blanket roll 110 is transferred to the plurality of convex portions 142a, but the ink 102 coated on the surface of the blanket roll 110 is not transferred to the plurality of concave portions 142b.

Due to the property, when the blanket roll 110 coated with the ink 102 rotates on the printing plate 140, the ink 102 on the blanket roll 110 corresponding to the convex portions 142a of the printing plate 140 is removed (Off) to be transferred to the convex portions 142a of the printing plate 140 in the rotating process. On the contrary, the ink 102 on the blanket roll 110 corresponding to the concave portions 142b of the printing plate 140 is left on the blanket roll 110 as it is to become a desired pattern 104.

The transferred substrate 150 is an attached object for transferring the ink pattern 104. When the blanket roll 110 on which the ink pattern 104 is formed rotates at predetermined speed and pressure on the transferred substrate 150, an ink pattern 105 is transferred (Set) onto the transferred substrate 150.

According to the exemplary embodiment of the present application, the surface tackiness of the printing layer may be an average value of values measured three times by using a ball tack test method in which a stainless spherical probe having a diameter of 1 inch is maintained for 30 seconds with a weight of 1000 g on the surface of the printing layer having a thickness of 400 μm under an atmosphere of 22° C. and relative humidity of 50%.

According to the exemplary embodiment of the present application, when the surface tackiness of the printing layer is measured by using the ball tack test method, the surface tackiness may be measured at a temperature of 22° C. within an error range of 2° C.

According to the exemplary embodiment of the present application, when the surface tackiness of the printing layer is measured by using the ball tack test method, the surface tackiness may be measured at the relative humidity of 50% within an error range of 5%.

According to the exemplary embodiment of the present application, the surface tackiness of the printing layer may be measured by using a XT plus Texture analyzer manufactured by Stable micro system corporation.

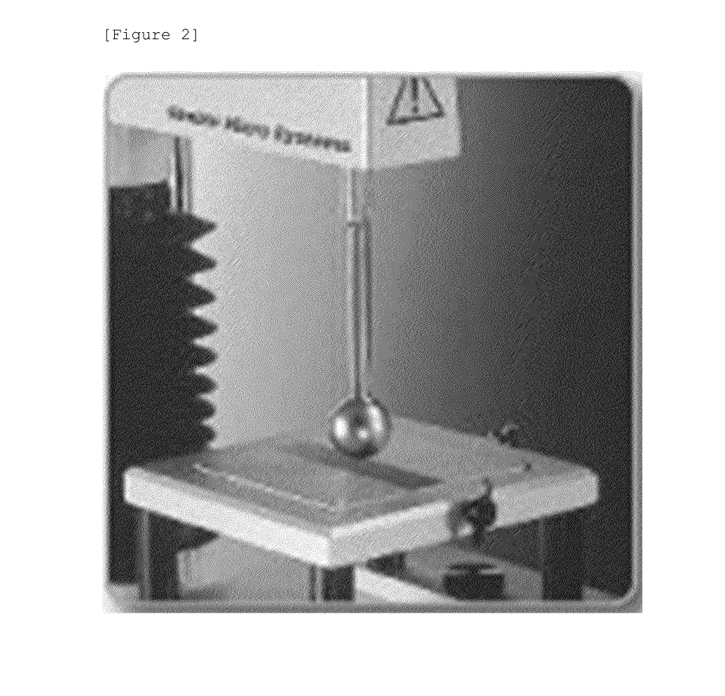

FIG. 2 is a diagram illustrating a ball tack test apparatus for measuring surface tackiness of a printing layer of a blanket for offset printing according to the exemplary embodiment of the present application.

Shore A hardness is used as a main physical property value used in the blanket for offset printing. However, the inventors found that in the case of a blanket for offset printing for forming a fine pattern, in detail, a pattern having a line width of 5 μm or less, even in the same shore A hardness value, a printing characteristic greatly varies. The inventors found that the reason is that the shore A hardness value is a very bulky property value and found a property value of the blanket for offset printing for forming the pattern having the line width of 5 μm or less so that an error rate is very small.

In detail, the inventors found that when the surface tackiness value of the printing layer of the blanket is maintained at 7 gf or more and 20 gf or less, the pattern having the line width of 5 μm or less may be stably formed.

When the surface tackiness value of the printing layer is more than 20 gf, a characteristic in which a proper pattern with the cliché is removed (Off) is not expressed while the unnecessary portion is removed (Off) by the convex pattern (cliché) of the printing plate, and a part is imperfectly fixed to the cliché to be pushed or damaged, and as a result, the error rate is increased when the fine pattern is formed.

When the surface tackiness value of the printing layer is less than 7 gf, an adhesive property of the blanket and the ink deteriorates, and before the fine pattern is transferred (Set) onto the substrate, the fine pattern is fully transferred to the cliché, and as a result, the fine pattern may not be formed.

The surface tackiness of the present application means a tackiness degree of the surface where the printing layer contacts the ink. In detail, the surface tackiness means the surface tackiness in a state where the ink is not coated on the surface of the printing layer. Since the printing layer may have a rubber-like property, printing quality of the ink may be determined by the degree of the surface tackiness.

According to the exemplary embodiment of the present application, the shore A hardness of the printing layer may be 20 or more and 70 or less. That is, the surface tackiness value of the printing layer is 7 gf or more and 20 gf or less, and simultaneously, the shore A hardness of the printing layer may be 20 or more and 70 or less.

The shore A hardness may be measured by a method based upon an ASTM D2240 test method, as a method of measuring hardness by using a depth at which an iron tip penetrates when predetermined force is applied.

According to the exemplary embodiment of the present application, in order to adjust the surface tackiness of the printing layer to 7 gf or more and 20 gf or less, the printing layer may be manufactured by controlling a curing agent, a catalyst amount, curing temperature and time, aging temperature and time, and the like.

According to the exemplary embodiment of the present application, the printing layer may include polydimethylsiloxane (PDMS). In detail, the printing layer of the present application may be made of PDMS.

According to the exemplary embodiment of the present application, the printing layer may further include a resin, a catalyst, a cross-linker, and an inhibitor.

According to the exemplary embodiment of the present application, the printing layer may be manufactured with a ratio of PDMS as a main material and the cross-linker of 10:1 to 2:1.

According to the exemplary embodiment of the present application, in order to control the surface tackiness value of the printing layer, the printing layer may be manufactured by controlling the aging time in an oven, after curing at room temperature. In detail, the aging may mean processing in an oven of 60° C. for 1 to 7 days.

According to the exemplary embodiment of the present application, the support layer uses at least one kind selected from a group consisting of polyethylene terephthalate (PET), polymethyl methacrylate (PMMA), polycarbonate (PC), polyethylene, and polypropylene, and may be a relatively flexible film. Further, as the support layer, materials which may be wound on the roll without wrinkles due to a flexible property, for example, a copper plate, a stainless steel (SUS) foil, and the like may be used in addition to the thermosetting film.

According to the exemplary embodiment of the present application, the support layer may be made of polyethylene terephthalate (PET), polymethyl methacrylate (PMMA), polycarbonate (PC), polyethylene, polypropylene, the copper plate, or the SUS foil.

According to the exemplary embodiment of the present application, the support layer may include a material in which a urethane-based compound is coated on polyethylene terephthalate (PET). In the case of PET used as the support layer, for adhesion with a primer in general non-treated PET, in the related art, the adhesion with the primer may be improved by performing plasma and corona processing and the like. However, in the processing method, generally, since the effect is not permanent and the surface processing effect is not large, in the present application, PET prepared by coating the urethane-based compound in PET may be used.

Since the PET is also expanded at a temperature around a glass transition temperature Tg during the thermosetting process of a silicon resin, PET having a higher grade than PET of a normal grade in heat stability may be used if possible. If not, after high-temperature exposure in which heat history is sufficiently removed is performed in the general PET, the general PET is used as the support layer to increase the size and position stability.

According to the exemplary embodiment of the present application, the thickness of the support layer may be 50 μm or more and 450 μm or less.

According to the exemplary embodiment of the present application, the thickness of the printing layer may be 100 μm or more and 800 μm or less. In detail, according to the exemplary embodiment of the present application, the thickness of the printing layer may be 200 μm or more and 500 μm or less. Further, for smooth printing, a standard deviation of the thickness of the printing layer may be less than 30 μm.

According to the exemplary embodiment of the present application, the thickness of the cushion layer may be 450 μm or more and 2,000 μm or less. In detail, according to the exemplary embodiment of the present application, the thickness of the cushion layer may be 700 μm or more and 2,000 μm or less.

The cushion layer serves to reduce nip pressure and distribute the pressure, and may be formed by using a material known in the art. In more detail, the material may be the same as the material forming the printing layer, and an existing silicon rubber including polydimethylsiloxane as a basic material may be used.

Foam particles may be included in the cushion layer in order to increase a cushion effect. The foam particles may use a material where inner holes are formed in a polymer resin shell, and the size of the particle is not particularly limited, but in order to have a good effect of controlling printing pressure, foam particles having particle sizes of 50 μm or more and 150 μm or less may be used. By adding the foam particles to the cushion layer, a printing pressure margin area of the blanket during printing, that is, a printing pressure range of uniform pattern printing may be further extended, and durability of the surface printing layer of the blanket may further be improved.

According to an exemplary embodiment of the present application, primer layers may be further included among the cushion layer, the support layer, and the printing layer, respectively.

According to the exemplary embodiment of the present application, the total thickness of the blanket for offset printing may be 0.6 μm or more and 2.45 mm or less.

In the case where the thickness of the blanket for printing is less than 0.6 μm, because a coating amount of a liquid silicon rubber is small, a labeling property during curing is not good and thus uniformity in thickness deteriorates, and as a result, the case is not preferred. In addition, in the case where the thickness of the blanket for printing is more than 2.45 mm, the blanket may not be properly bent but be folded when the blanket is wound around a main roll, and as a result, the case is not preferred.

The present application provides a printing roll including the blanket for offset printing covering a periphery of the roll support.

The present application provides a fine pattern having a line width of 1 μm or more and 5 μm or less formed by using the blanket for offset printing.

Hereinafter, for describing the present application in detail, the present application will be described in detail with reference to Examples. However, Examples according to the present application may be modified in various forms, and it is understood that the scope of the present application is not limited to Examples to be described in detail below. The Examples of the present application are provided for more completely describing the present application to those skilled in the art.

### Example 1

A mesh pattern having a line width of 4.5 μm was formed by a reverse offset method by using a blanket for offset printing of which surface tackiness of a printing layer having a thickness of 400 μm manufactured by using PDMS is 7 gf.

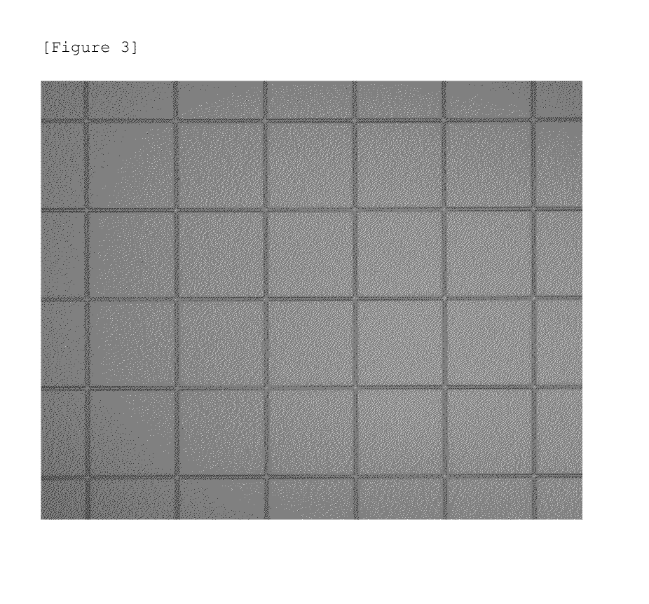

FIG. 3 is a diagram illustrating a mesh pattern having a line width of 4.5 μm formed according to Example 1.

### Example 2

A mesh pattern having a line width of 4.5 μm was formed by a reverse offset method by using a blanket for offset printing of which surface tackiness of a printing layer having a thickness of 400 μm manufactured by using PDMS is 12 gf. In Example 2, a normal mesh pattern was formed without a defect pattern like Example 1.

### Example 3

A mesh pattern having a line width of 4.5 μm was formed by a reverse offset method by using a blanket for offset printing of which surface tackiness of a printing layer having a thickness of 400 μm manufactured by using PDMS is 20 gf. In Example 3, a normal mesh pattern was formed without a defect pattern like Example 1.

### Comparative Example 1

It was tried that a mesh pattern having a line width of 4.5 μm was formed by a reverse offset method by using a blanket for offset printing of which surface tackiness of a printing layer having a thickness of 400 μm manufactured by using PDMS is 5 gf. However, in the case of Comparative Example 1, ink during reverse offset printing was fully removed to the cliché and thus the formation of the pattern was failed.

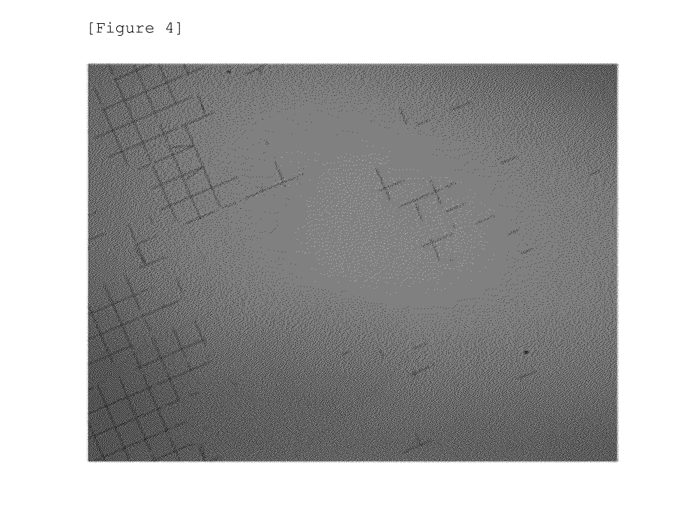

FIG. 4 illustrates a printed result according to Comparative Example 1. In detail, in FIG. 4, it can be seen that a print defect occurs when the pattern is formed in Comparative Example 1.

### Comparative Example 2

It was tried that a mesh pattern having a line width of 4.5 μm was formed by a reverse offset method by using a blanket for offset printing of which surface tackiness of a printing layer having a thickness of 400 μm manufactured by using PDMS is 25 gf. However, in the case of Comparative Example 2, a defect pattern having many residues was formed.

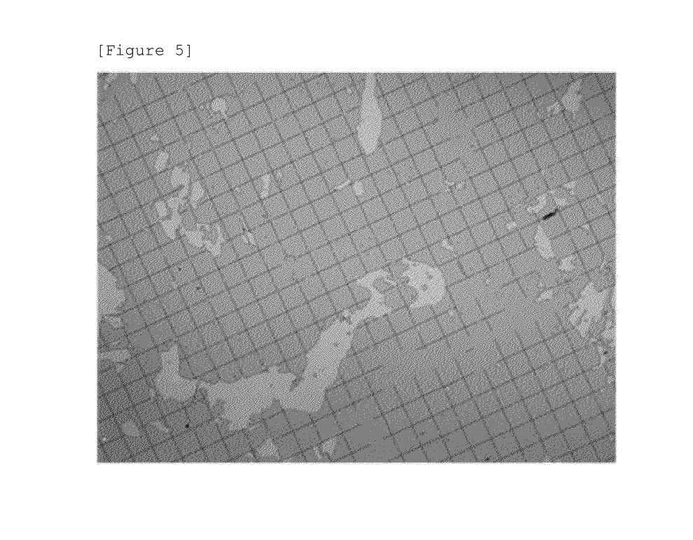

FIG. 5 illustrates a printed result according to Comparative Example 2. In detail, in FIG. 5, it can be seen that a print defect occurs due to the generation of the residues.

### Comparative Example 3

A mesh pattern having a line width of 4.5 μm was formed by a reverse offset method by using a blanket for offset printing of which surface tackiness of a printing layer having a thickness of 400 μm manufactured by using PDMS is 50 gf. However, in the case of Comparative Example 3, the ink is not removed (Off) to the cliché and thus the formation of the pattern was failed.

TABLE 1

| | | Formation of | |
|---|---|---|---|
| | Tackiness | pattern having | |
| | (gf) | line width of 4.5 μm | Note |
| Example 1 | 7 | Normal | Formation of pattern |
| Example 2 | 12 | Normal | Formation of pattern |
| Example 3 | 20 | Normal | Formation of pattern |
| Comparative | 5 | Defect | Non-formation of |
| Example 1 | | | pattern |
| | | | (Cliché fully off) |
| Comparative | 25 | Defect | Generation of residues |
| Example 2 | | | |
| Comparative | 50 | Defect | No printing |
| Example 3 | | | |

1. A blanket for offset printing, comprising:
a cushion layer;
a support layer provided on the cushion layer; and
a printing layer provided on the support layer,
wherein the surface tackiness of the printing layer is 7 gf or more and 20 gf or less.

2. The blanket for offset printing of claim 1, wherein the surface tackiness of the printing layer is an average value of values measured three times by using a ball tack test method in which a stainless spherical probe having a diameter of 1 inch is maintained for 30 seconds with a weight of 1000 g on the surface of the printing layer having a thickness of 400 μm under an atmosphere of 22° C. and relative humidity of 50%.

3. The blanket for offset printing of claim 1, wherein shore A hardness of the printing layer is 20 or more and 70 or less.

4. The blanket for offset printing of claim 1, wherein the printing layer includes polydimethylsiloxane (PDMS).

5. The blanket for offset printing of claim 4, wherein the printing layer further includes a resin, a catalyst, a cross-linker, and an inhibitor.

6. The blanket for offset printing of claim 1, wherein the support layer is made of polyethylene terephthalate (PET), polymethyl methacrylate (PMMA), polycarbonate (PC), polyethylene, polypropylene, a copper plate, or an SUS foil.

7. The blanket for offset printing of claim 1, wherein the support layer includes an urethane-based compound coated on polyethylene terephthalate (PET).

8. The blanket for offset printing of claim 1, wherein the thickness of the support layer is 50 μm or more and 450 μm or less.

9. The blanket for offset printing of claim 1, wherein the thickness of the printing layer is 100 μm or more and 800 μm or less.

10. The blanket for offset printing of claim 1, wherein the thickness of the cushion layer is 450 μm or more and 2,000 μm or less.

11. The blanket for offset printing of claim 1, further comprising:
primer layers among the cushion layer, the support layer, and the printing layer, respectively.

12. The blanket for offset printing of claim 1, wherein the total thickness of the blanket for offset printing is 0.6 μm or more and 2.45 mm or less.

13. A printing roll including the blanket for offset printing of claim 1, which covers a periphery of a roll type support.

14. A fine pattern having a line width of 1 μm or more and 5 μm or less formed by using the blanket for offset printing of claim 1.
